(19) United States
(12) Patent Application Publication
(10) Pub. No.: US 2003/0227694 A1
(43) Pub. Date: Dec. 11, 2003

(54) Laser diode module, laser diode device and optical transmitter incorporating the same

(75) Inventors: Toshihiro Hosoya, Tokyo (JP); Yasushi Saito, Tokyo (JP); Hirofumi Higuchi, Tokyo (JP)

Correspondence Address: SUGHRUE MION, PLLC, 2100 Pennsylvania Avenue, NW, Washington, DC, 20037-3213, US

(73) Assignee: HITACHI KOKUSAI ELECTRIC INC.

(21) Appl. No.: 10/414,488

(22) Filed: Apr. 16, 2003

(30) Foreign Application Priority Data
Apr. 16, 2002 (JP) P2002-113523
Oct. 28, 2002 (JP) P2002-312791
Feb. 26, 2003 (JP) P2003-049650

(51) Int. Cl. G02B 7/02

(52) U.S. Cl. 359/820

(57) ABSTRACT

In a laser diode module, a laser diode chip is disposed in a module casing. A heater heats the laser diode chip such that at least a temperature of the laser diode chip is kept constant. A temperature detector detects a temperature of the laser diode module. A temperature controller controls a calorific value of the heater in accordance with the detected temperature of the laser diode module. The temperature controller keeps the temperature of the laser diode module at a temperature higher than an operative temperature of a laser diode device incorporating the laser diode module.

### BACKGROUND OF THE INVENTION

The present invention relates to an uncooled type laser diode module and a laser diode device incorporating the laser diode module, and an optical transmitter incorporating the laser diode device.

An optical transmitter used in a cable television or the like incorporates a semiconductor laser diode as an optical signal generator. Various characteristics, such as the slope efficiency, distortion and others, of the semiconductor laser diode, greatly vary depending on a temperature of a laser diode chip. To cope with this, a cooler is contained in the laser diode device to keep the temperature of the laser diode chip at a fixed value of about 25° C., so that generation of distortion is suppressed and a stable operation of the laser diode is secured (disclosed in Japanese Patent Publication No. 5-90698A, for example).

In the case of the cooler contained laser diode, the chip per se is merely cooled. Accordingly, a deviation of an internal optical system, such as lenses and an isolator, which is caused by ambient temperature variation, causes a variation of an optical output level of an optical signal. Further, the laser diode is complicated in structure, large in package and hence high in cost to manufacture.

For this reason, in recent days, the laser diode module of the uncooled type in which the cooler is not contained has been used. The laser diode module of the uncooled type has advantages of size reduction of the package and cost reduction since it does not contain the cooler.

However, it is disadvantageous in that during its operation, its temperature varies, and with temperature variation, the distortion quantity and the distortion characteristic greatly vary.

### SUMMARY OF THE INVENTION

It is therefore an object of the invention to provide a laser diode module, a laser diode device, and an optical transmitter in which operation temperature is kept constant to thereby prevent a distortion variation, and the cost to manufacture is made low.

In order to achieve the above object, according to the invention, there is provided a laser diode module, comprising:

a module casing;

a laser diode chip, disposed in the module casing; and

a heater, which heats the laser diode chip such that at least a temperature of the laser diode chip is kept constant.

Preferably, the heater is disposed outside the module casing to keep a temperature of the module casing constant.

Preferably, the heater is a constant-temperature heat generating element comprising a PTC (positive temperature coefficient) thermistor.

The heater may be disposed inside the module casing. In this case, it is preferable that the heater heats at least the laser diode chip and an optical system through which a laser beam emitted from the laser diode chip passes.

According to the Invention, there is also provided a laser diode device, comprising:

the above laser diode module;

a temperature detector, which detects a temperature of the laser diode module; and

a temperature controller, which controls a calorific value of the heater in accordance with the detected temperature of the laser diode module.

Preferably, the temperature controller keeps the temperature of the laser diode module at a temperature higher than an operative temperature of the laser diode device.

According to the invention, there is also provided a laser diode module, comprising:

a module casing;

a laser diode chip, disposed in the module casing; and

a Peltier element, disposed outside the module casing to keep at least a temperature of the laser diode chip constant.

According to the invention, there is also provided a laser diode device, comprising:

the above laser diode module;

a temperature detector, which detects a temperature of the laser diode module; and

a temperature controller, which controls an operation state of the Peltier element in accordance with the detected temperature of the laser diode module.

According to the invention, there is also provided an optical transmitter, comprising the above laser diode device in order to convert an inputted electric signal into an optical signal to be transmitted.

Preferably, the optical transmitter further comprises a distortion compensator, provided in an input side of the laser diode device to previously compensate a distortion to be generated at an output side of the laser diode device. Here, a compensation characteristic of the distortion compensator is optimized at the controlled temperature of the laser diode module.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing a configuration of a laser diode device according to a first embodiment of the invention;

FIG. 2 is a diagram showing the details of an essential portion of the laser diode device;

FIG. 3 is a diagram showing a configuration of a temperature controller in the laser diode device;

FIG. 4 is a block diagram showing a configuration of an optical transmitter incorporating the laser diode device;

FIG. 5 is a block diagram showing a configuration of a laser diode device according to a second embodiment of the invention;

FIG. 6 is a block diagram showing a configuration of a laser diode device according to a third embodiment of the invention; and

FIG. 7 is a diagram showing a configuration of a laser diode device according to a fourth embodiment of the invention.

### DETAILED DESCRIPTION OF THE PREFERRED EMBODIMENTS

Preferred embodiments of the invention will be described with reference to the accompanying drawings.

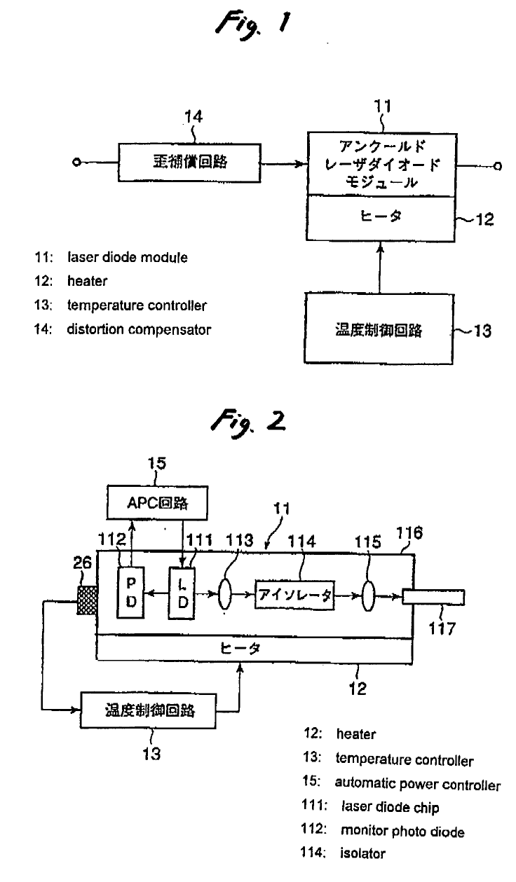

FIG. 1 is a block diagram showing a configuration of a laser diode device according to a first embodiment of the present invention. In this embodiment, a laser diode module 11 of the uncooled type converts a high frequency analog signal, for example, into an optical signal to be outputted. A heater 12 keeps the temperature of the laser diode module 11 at a fixed value of temperature. The heater 12 may be directly mounted on the laser diode module 11, or may be mounted on, for example, a fitting member, a board member or the like for holding the laser diode module 11. In this case, the laser diode module 11 and the heater 12 may be provided within a specific casing.

A calorific value of the heater 12 is controlled by a temperature controller 13 so as to keep the temperature of the laser diode module 11 at a fixed value of temperature, which is higher than ambient temperature. In a case where given performances of an apparatus using the laser diode module 11 are guaranteed when an operative ambient temperature of the apparatus is specified within a range of −20° C. to +40° C., the temperature controller 13 operates so as to keep the temperature of the laser diode module 11 at a fixed value of temperature, for example, 65° C., which is higher than 40° C. as the upper limit value of the operative ambient temperature. By so doing, the laser diode module 11 is kept at a fixed temperature value even if the ambient temperature varies within the range of the operative ambient temperatures. A laser diode module which stably and reliably operates at a temperature higher than the operative ambient temperatures is used for the laser diode module 11. Such a temperature is about 65° C., in this case. A laser diode module, preferably used for the laser diode module 11, is able to operate at a temperature higher than the operative ambient temperature, about 65° C. in this case.

The details of the laser diode module 11 and the temperature controller 13 will be described later.

A high frequency signal for transmission is inputted to the laser diode module 11 through a distortion compensator 14. The distortion compensator 14 compensates for secondary and tertiary distortions of the high frequency signal as input thereto by the utilization of the technique disclosed in Japanese Patent Publications Nos. 10-102718A and 9-126284A, for example. In particular, a compensating characteristic of the distortion compensator is selected so as to compensate for distortions generated at a temperature at which the laser diode module 11 is kept by the temperature controller 13. The laser diode module 11 converts the high frequency input signal into an optical signal to be outputted through an optical cable.

The laser diode module 11 is configured as shown in FIG. 2. The laser diode module 11 is made up of an LD (laser diode) chip 111, a monitor PD (photo diode) 112, a first lens 113, an isolator 114, and a second lens 115, and is housed in a casing 116.

The LD chip 111 converts an externally-inputted high frequency signal into laser light, and outputs the same. The laser light is outputted from the laser diode module 11, through the first lens 113, the isolator 114, the second lens 115 and the optical fiber 117.

The monitor PD 112 receives and converts laser light that is outputted from the LD chip 111 into an electrical signal to be outputted to an automatic power controller 15. The automatic power controller 15 controls a drive circuit of the LD chip 111 in accordance with a signal derived from the monitor PD 112. By the control, an optical output level of an optical signal outputted from the LD chip 111 is always constant. In a case where the laser diode module 11 is constant-current driven, when temperature rises, the output level of the optical signal outputted from the laser diode module 11 decreases, and when temperature decreases, the optical output level of the optical signal increases. To cope with this, as described above, laser light outputted from the LD chip 111 is detected by the monitor PD 112, and the drive circuit of the LD chip 111 is controlled by the automatic power controller 15 so that the output level of the optical signal output therefrom is made constant.

The heater 12 is mounted on the outside of the laser diode module 11, i.e., the outside of the casing 116. Further, a heat sensitive element, e.g., an NTC (negative temperature coefficient) thermistor (referred to simply as a thermistor) 26, is mounted on the laser diode module 11. Similarly, the thermistor 26 may be directly mounted on the laser diode module 11, or may be mounted on, for example, the fitting member or the board member for holding the laser diode module 11.

The thermistor 26 is an element for detecting temperature of the laser diode module 11, and a detection signal is inputted to the temperature controller 13. The temperature controller 13 controls the heater 12 in accordance with the detection signal from the thermistor 26, and keeps the temperature of the laser diode module 11 at a fixed value of temperature, for example, 65° C.

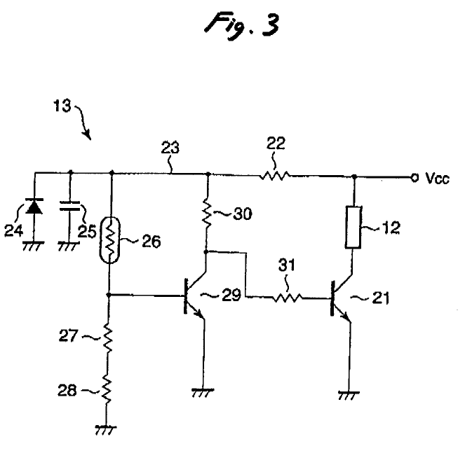

The temperature controller 13 is configured as shown in FIG. 3 Specifically, a voltage Vcc supplied from a DC power source circuit (not shown) is inputted to a collector of a power transistor 21, through the heater 12, and further to a power line 23 through a resistor 22. A parallel circuit including a constant-voltage diode 24 and a capacitor 25 is connected between the power line 23 and ground, whereby a voltage on the power line 23 is kept constant.

A series circuit including the thermistor 26 and bias resistors 27 and 28, which are connected in series, is connected between the power line 23 and ground. A divided voltage appearing at a node between the thermistor 26 and the bias resistor 27 is inputted to the base of the amplifying transistor 29.

The amplifying transistor 29 receives at the collector a voltage on the power line 23 via a load resistor 30, and is grounded at the emitter. The collector voltage of the amplifying transistor 29 is inputted to the base of the power transistor 21 through the bias resistor 31. The power transistor 21 is grounded at the emitter.

In the temperature controller thus constructed, when the temperature of the laser diode module 11 is low, temperature of the thermistor 26 is also low and its resistance is large. Accordingly, a divided voltage at the node between the thermistor 26 and the bias resistor 27 is low, and a base current of the amplifying transistor 29 reduces. As a result, a collector voltage of the amplifying transistor 29 becomes high. A base current of the power transistor 21 reduces. A current flowing into the heater 12 reduces, and a heating temperature for the laser diode module 11 increases.

When the temperature of the laser diode module 11 becomes high, the temperature of the thermistor 26 also becomes high, and its resistance decreases. The divided voltage at the node between the thermistor 26 and the bias resistor 27 increases, and a base current to the amplifying transistor 29 increases. As a result, the collector voltage of the amplifying transistor 29 becomes low, the base current of the power transistor 21 decreases, the current flowing into the laser diode module 11 decreases, and the heating temperature for the laser diode module 11 decreases.

As described above, the current to the heater 12 is controlled so that the temperature of the laser diode module 11 is kept constant. A set temperature for the laser diode module 11 may be adjusted by appropriately selecting the values of the bias resistors 27 and 28. Accordingly, the values of the bias resistors 27 and 28 are selected so that the laser diode module 11 is kept at an appropriate temperature, e.g., 65° C.

As described above, the heater 12 and the temperature controller 13 cooperate to keep the temperature of the laser diode module 11 at a fixed value of temperature. As a result, a distortion generated in the laser diode module 11 may be kept constant. In this state, the laser diode module 11 and the distortion compensator 14 are combined, and a distortion compensation by the distortion compensator 14 is optimized at a temperature (e.g., 65° C.) at which the laser diode module 11 is kept, whereby great distortion improvement is secured.

By keeping the entire temperature of the laser diode module 11 constant, deviation of not only the LD chip 111 but also the optical system, such as the first lens 113, the isolator 114 and the casing 116, may be suppressed, whereby a tracking error is surely prevented. Accordingly, an output level of an optical signal at the output terminal of the laser diode module 11 may be kept constant.

When comparing with the a laser diode module containing the cooler, the laser diode module 11 is smaller in size, and simple in structure, and the package per se is very low in cost. Accordingly, even if the externally mounted heater 12 is provided, the laser diode module 11 may be manufactured at low cost.

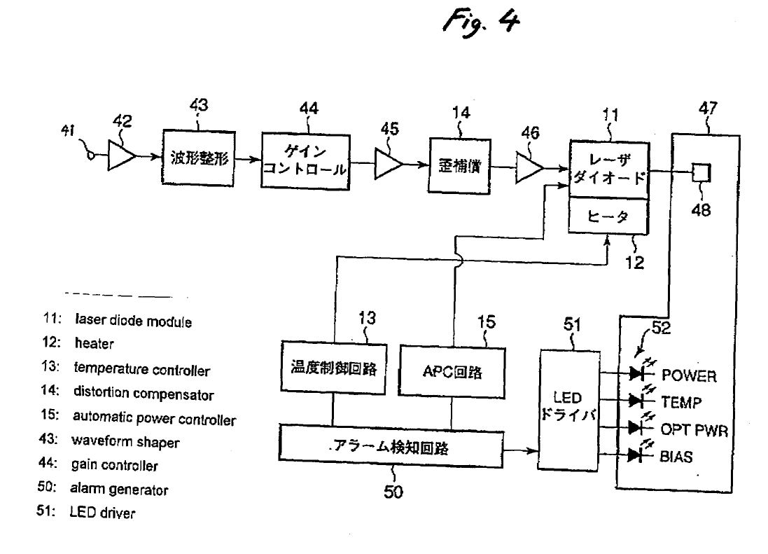

An arrangement of an optical transmitter using the laser diode module 11 described above will be described with reference to FIG. 4. A high frequency signal inputted to an input terminal 41 is amplified by an amplifier 42, wave-shaped by a waveform shaper 43, and gain-adjusted by a gain controller 44. After then, the high frequency signal is inputted to the laser diode module 11, through an amplifier 45, the distortion compensator 14 and an amplifier 46. The laser diode module 11 converts the inputted high frequency signal into an optical signal, and outputs the same through an optical cable (not shown) via an optical connector 48 provided on a front panel 47.

The laser diode module 11 is kept at a fixed value of temperature by the combination of the heater 12 and the temperature controller 13, and is controlled, by the automatic power controller 15, to produce an optical signal having always a fixed output level.

An alarm generator 50 is connected to the temperature controller 13 and the automatic power controller 15. The alarm generator 50 monitors operation statuses of the temperature controller 13 and the automatic power controller 15, and when it detects an abnormality, it transmits an alarm signal to an LED (light emitting device) driver 51.

The LED driver 51 controls the turning-on/off of a plurality of status LEDs 52 provided on the front panel 47 in accordance with a signal outputted from the alarm generator 50. The status LEDs 52 indicate a power status (POWER), temperature (TEMP) of the laser diode module 11, an output status of the optical signal (OPT PWR), an LD bias status (BIAS) by the automatic power controller 15, or the like.

Therefore, a high performance optical transmitter which is remarkably reduced in distortion occurrence and low in cost may be constructed not using the cooler-contained laser diode module. Further, great distortion improvement is secured by combining the laser diode module 11 and the distortion compensator 14 such that a distortion compensation by the distortion compensator 14 is optimized at a temperature (e.g., 65° C.) at which the laser diode module 11 is kept.

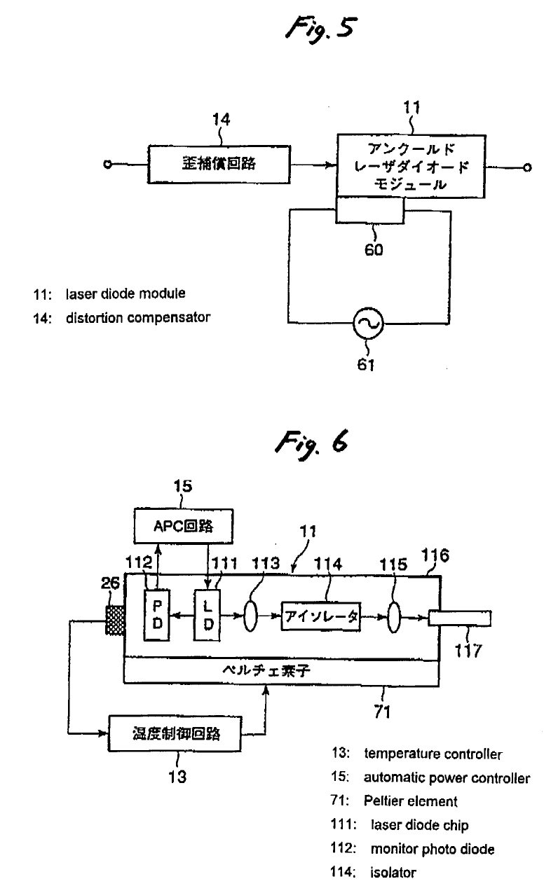

A second embodiment of the present invention will be described with reference to FIG. 5. As shown, a constant-temperature heat generating body 60 incorporating a PTC thermistor therein is directly mounted on a casing of the laser diode module 11. Electric power is supplied from a power source, e.g., an AC power source 61, to the PTC thermistor. By utilizing heat generated by the PTC thermistor, the laser diode module 11 is kept at a temperature higher than operative ambient temperature, for example, a fixed temperature of 65° C. Distortion of the laser diode module 11 is compensated by the distortion compensator 14.

The PTC thermistor is a semiconductor resistor element, and has a nature that its resistance steeply increases with increase of temperature, and its switching temperature may be set by appropriately selecting its material compositions. The PTC thermistor has such a characteristic that at low temperatures, a resistance value of the thermistor is low and large current flows therethrough, but at temperatures higher than a given temperature, its resistance value steeply increases and little current flows therethrough. Accordingly, the PTC thermistor may be used as a heat generator of the constant-temperature heat generating body 60 by the utilization of the temperature characteristic mentioned above.

In such a configuration, the temperature controller may be simplified in construction when the temperature of the laser diode module 11 is kept at a fixed value of temperature by use of the constant-temperature heat generating body 60. The constant-temperature heat generating body 60 may be directly mounted on the laser diode module 11, or may be mounted on, for example, a fitting member, or a board member for holding the laser diode module 11.

When the laser diode module 11 is kept at a fixed value of temperature and the distortion compensation by the distortion compensator 14 is optimized at that temperature value, great distortion improvement is secured.

In the second embodiment, the constant-temperature heat generating body 60 is externally mounted on the casing of the laser diode module 11. In an alternative, the constant-temperature heat generating body 60 is provided within the casing of the laser diode module 11, viz, near the LD chip 111. And the temperature of the LD chip 111 is kept at a fixed value of temperature, for example, 65° C., as described above. In this case, a lead wire of the constant-temperature heat generating body 60 is led out of the casing of the laser diode module 11, and connected to a power source, for example, the AC power source 61, as in the second embodiment.

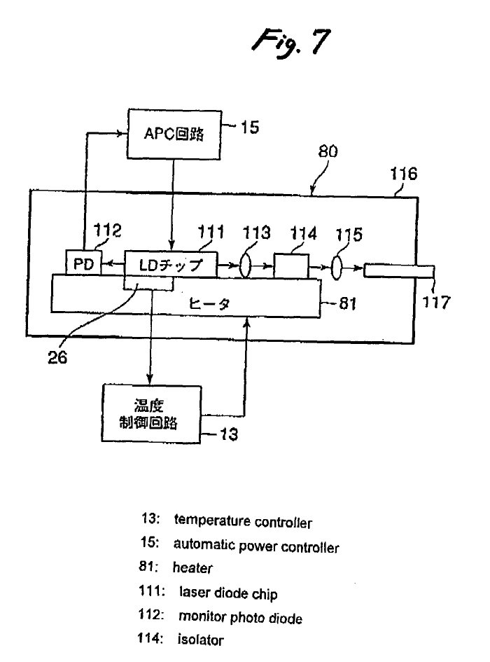

A third embodiment of the invention will be described with reference to FIG. 6. In this embodiment, a cooler element, for example, a Peltier element 71, is used in place of the heater 12 in the first embodiment. A configuration of the laser diode module 11 is similar to that of the first embodiment shown in FIG. 2. Hence, like or equivalent portions are designated by like reference numerals in FIG. 2.

The Peltier element 71 is mounted on the outside of the laser diode module 11, for example, on the outside of the casing 116. And a heat sensing element, e.g., the thermistor 26, is also mounted on the casing 116. The Peltier element 71 and the thermistor 26 may be mounted on, for example, a fitting member or a board member for holding the laser diode module 11.

The thermistor 26 detects temperature of the laser diode module 11, and transmits a detection signal to the temperature controller 13. In turn, the temperature controller 13 controls the Peltier element 71 in accordance with the detection signal from the thermistor 26 so that the temperature of the laser diode module 11 is kept at a fixed value of temperature, for example, 25° C.

By controlling the Peltier element 71 by the temperature controller 13, the temperature of the whole of the laser diode module 11 may be kept at a fixed value of temperature. As in the first embodiment, deviation of not only the LD chip 111 but also the optical system may be suppressed to thereby prevent the tracking error and to keep an output level of an optical signal constant.

When comparing with the a laser diode module containing the cooler, the laser diode module 11 is simple in structure, and the package per se is very low in cost. Accordingly, even if the externally mounted Peltier element 71 is provided, the laser diode module may be manufactured at low cost.

Further, by keeping the temperature of the laser diode module 11 at a fixed value of temperature, a distortion generated in the laser diode module 11 may be kept constant. Further, great distortion improvement is secured by combining the laser diode module 11 and the distortion compensator 14 as in the first and second embodiments, so that a distortion compensation by the distortion compensator 14 is optimized at the controlled temperature. The resultant optical transmitter is low in cost and high in performance.

The laser diode module 11 is normally set and kept at about 25° C. by the temperature controller 13. If necessary, the temperature at which the laser diode module is kept may be higher than 25° C., for example, 65° C.

A fourth embodiment of the invention will be described with reference to FIG. 7. In this embodiment, a heater 81 is contained in a laser diode module 80 of the uncooled type. A laser diode module which stably and reliably operates at a temperature higher than the operative ambient temperature is used for the laser diode module 80. Such a temperature is about 65° C., for example.

The laser diode module 80 contains an LD chip 111, a monitor PD 112, a first lens 113, an isolator 114, a second lens 115 and a heater 81 for heating the LD chip 111, and is contained in a casing 116. A heat sensitive element, for example, a thermistor 26, is disposed near the LD chip 111 within the casing 116, and detects a temperature of or near the LD chip 111.

Laser light outputted from the LD chip 111 is led out through the first lens 113, the isolator 114, the second lens 115 and the optical fiber 117.

The monitor PD 112 receives and converts the laser light outputted from the LD chip 111 into an electrical signal to be outputted to the externally-provided automatic power controller 15. The automatic power controller 15 controls an output level of an optical signal outputted from the LD chip 111 in accordance with a signal outputted from the monitor PD 112 so that the optical output level is kept constant.

The thermistor 26 is connected to the temperature controller 13 provided outside the laser diode module 80. The thermistor 26 detects a temperature within the casing 116, for example, a temperature of or near the LD chip 111, and the temperature controller 13 controls a heat value of the heater 81 by use of its drive current based on the detected temperature, and keeps the temperature of the heater 81 at a fixed value of temperature, for example, 65° C.

A laser diode module which stably and reliably operates at a temperature higher than normal temperature is used for the laser diode module 80. By so doing, the temperature of the laser diode module 80 containing the heater 81 may be kept at a fixed value of temperature. As a result, the temperature control is considerably readily carried out with a simple construction, leading to cost reduction.

Further, great distortion improvement is secured by combining the laser diode module 80 and the distortion compensator 14 as in the first and second embodiments, and a distortion compensation by the distortion compensator 14 is optimized at the controlled temperature. The resultant optical transmitter is low in cost and high in performance.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims

What is claimed is:

1. A laser diode module, comprising:
a module casing;
a laser diode chip, disposed in the module casing; and
a heater, which heats the laser diode chip such that at least a temperature of the laser diode chip is kept constant.

2. The laser diode module as set forth in claim 1, wherein the heater is disposed outside the module casing to keep a temperature of the module casing constant.

3. The laser diode module as set forth in claim 1, wherein the heater is a constant-temperature heat generating element comprising a positive temperature coefficient thermistor.

4. The laser diode module as set forth in claim 1, wherein the heater is disposed inside the module casing.

5. The laser diode module as set forth in claim 4, further comprising an optical system through which a laser beam emitted from the laser diode chip passes,
wherein the heater heats at least the laser diode chip and the optical system.

6. A laser diode module, comprising:
a module casing;
a laser diode chip, disposed in the module casing; and
a Peltier element, disposed outside the module casing to keep at least a temperature of the laser diode chip constant.

7. A laser diode device, comprising;
the laser diode module as set forth in claim 1;
a temperature detector, which detects a temperature of the laser diode module; and
a temperature controller, which controls a calorific value of the heater in accordance with the detected temperature of the laser diode module.

8. The laser diode device as set forth in claim 7, wherein the temperature controller keeps the temperature of the laser diode module at a temperature higher than an operative temperature of the laser diode device.

9. A laser diode device, comprising:
the laser diode module as set forth in claim 6;
a temperature detector, which detects a temperature of the laser diode module; and
a temperature controller, which controls an operation state of the Peltier element in accordance with the detected temperature of the laser diode module.

10. An optical transmitter, comprising the laser diode device as set forth in claim 7 or 9 in order to convert an inputted electric signal into an optical signal to be transmitted.

11. The optical transmitter as set forth in claim 10, further comprising a distortion compensator, provided in an input side of the laser diode device to previously compensate a distortion to be generated at an output side of the laser diode device,
wherein a compensation characteristic of the distortion compensator is optimized at the controlled temperature of the laser diode module.
